(19) United States
(12) Patent Application Publication
(10) Pub. No.: US 2008/0045281 A1
(43) Pub. Date: Feb. 21, 2008

(54) Sliding mechanism for slide-type portable electronic device

(75) Inventors: Nan-Tsung Huang, Shindian (TW); Chen-Hui Wu, Shindian (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: Sutech Trading Limited, Tortola (VG)

(21) Appl. No.: 11/653,828

(22) Filed: Jan. 12, 2007

(30) Foreign Application Priority Data
Jun. 30, 2006 (CN) 200610061421.0

(51) Int. Cl. H04M 1/00

(52) U.S. Cl. 455/575.4

(57) ABSTRACT

A sliding mechanism (100) for a portable electronic device (500) includes a first sliding member (10), a second sliding member (20), and at least one cushion (30). The first sliding member has a first body (11). At least one guiding rail (12) is formed on the first body. The second sliding member has a second body (21). At least one guiding arm (22) is formed on the second body. The guiding arm defines a guiding slot (224) therein. The cushion has a main body (31). The main body defines a receiving slot (314) therein. The guiding rail is configured for reception in the receiving slot. The cushion is sandwiched between the guiding rail and the guiding arm.

### CROSS-REFERENCE TO RELATED APPLICATION

This application is related to a co-pending U.S. patent application (Attorney Docket No. [US11079]), entitled “SLIDING MECHANISM FOR SLIDE-TYPE PORTABLE ELECTRONIC DEVICE”, by Chen-Hui Wu. Said application has the same assignee as the present application and is concurrently filed herewith. The disclosure of the above-identified application is incorporated herein by reference.

### BACKGROUND OF THE INVENTION

1. Field of the Invention

The present invention generally relates to sliding mechanisms for slidably connecting two members and, more particularly, to a sliding mechanism configured (i.e., structured and arranged) for use in a slide-type portable electronic device to slidably interconnect two cases of the device.

2. Description of Related Art

Currently, of the various portable terminal designs, slide-type portable electronic devices have become increasingly popular. The slide-type portable electronic device is configured to have two housings. One of the housings slides over the other housing, thereby opening/closing the portable electronic device, by means of a sliding mechanism.

A typical sliding mechanism includes two guiding rails symmetrically formed on two sides of one housing. The other housing has two guiding arms formed at two sides thereof. Each guiding arm defines a guiding slot therein. The guiding rails are configured for receipt in the two guiding slots. The size of each guiding rail is slightly smaller than the size of the guiding slot. That is to say there is a small clearance between the guiding rail and the guiding arm. The guiding rails are slidable in the guiding slots thereby allowing one housing to slide relative to the other housing. However, the guiding rails and the guiding arms are likely to undergo wear and tear because of continual friction between them, and correspondingly the clearance may become wider and wider. Thus, the two housings may not fit properly to each other. That is to say one housing may shake relative to the other housing.

Therefore, a new sliding mechanism for slide-type portable devices is desired in order to overcome the above-described shortcomings.

### SUMMARY

In one embodiment thereof, a sliding mechanism for a portable electronic device includes a first sliding member, a second sliding member, and at least one cushion. The first sliding member has a first body. At least one guiding rail is formed at the first body. The second sliding member has a second body. At least one guiding arm is formed at the second body. The guiding arm defines a guiding slot therein. The cushion has a main body. The main body defines a receiving slot therein. The guiding rail is configured for receipt in the receiving slot. The cushion is sandwiched between the guiding rail and the guiding arm.

Other advantages and novel features of the embodiments will become more apparent from the following detailed description thereof when taken in conjunction with the accompanying drawings.

### BRIEF DESCRIPTION OF THE DRAWINGS

Many aspects of the present sliding mechanism can be better understood with reference to the following drawings. The components in the drawings are not necessarily drawn to scale, the emphasis instead being placed upon clearly illustrating the principles of the sliding mechanism and its potential applications. Moreover, in the drawings, like reference numerals designate corresponding parts throughout the several views.

FIG. 1 is an exploded, isometric view of a sliding mechanism having two cushions, in accordance with a preferred embodiment;

FIG. 2 is an isometric view of the cushion in FIG. 1;

FIG. 3 is an isometric, cut-away view of the cushion along line III-III in FIG. 2;

FIG. 4 is an assembled, isometric view of the cushion in FIG. 1;

FIG. 5 is an isometric, cut-away view of the sliding mechanism along line V-V in FIG. 4; and

FIG. 6 is an isometric view of a portable electronic device equipped with the sliding mechanism in FIG. 1.

### DETAILED DESCRIPTION OF THE EMBODIMENTS

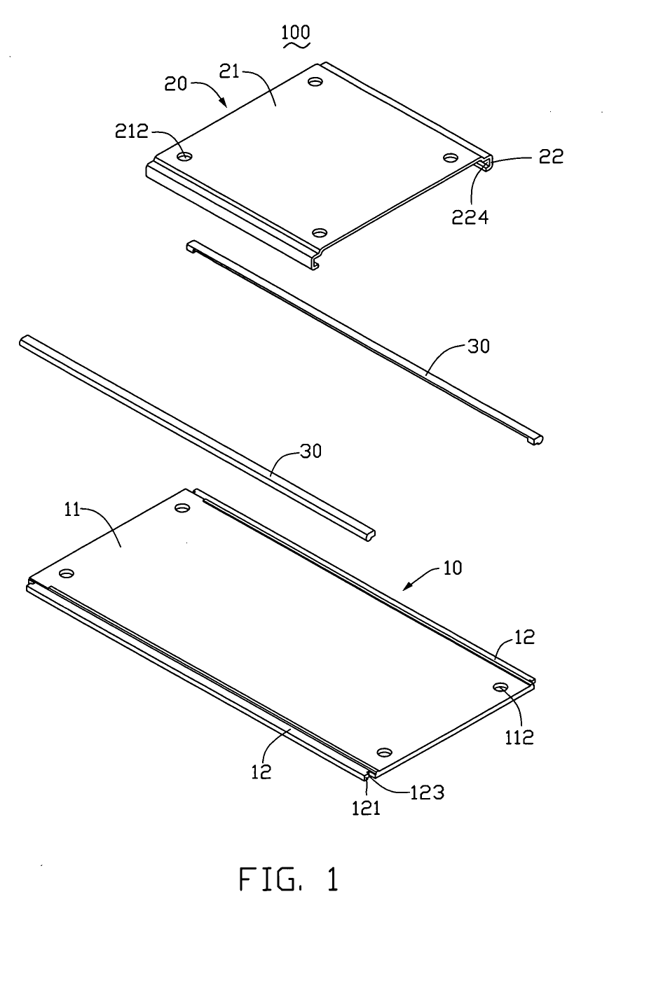

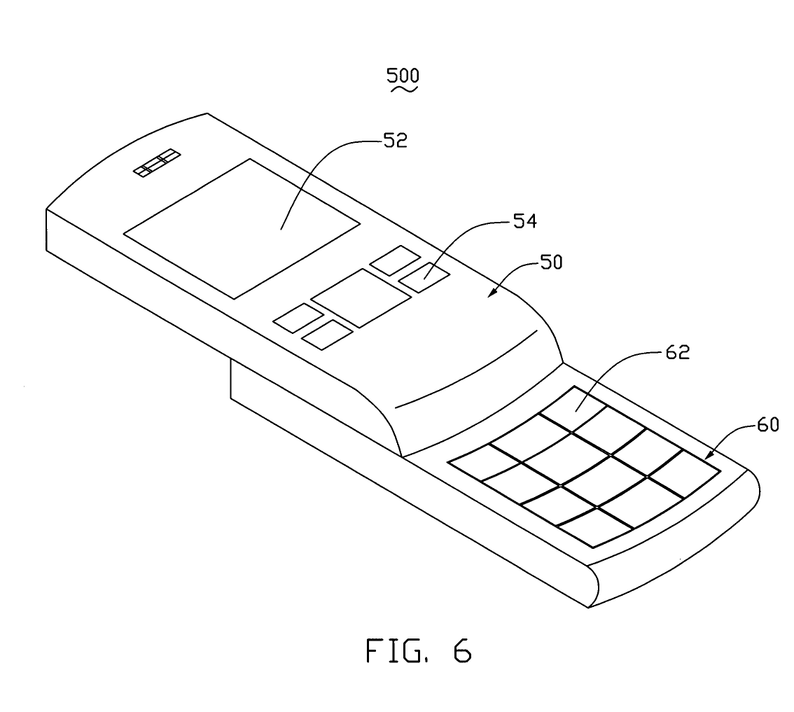

FIGS. 1 and 6 show a sliding mechanism 100 according to a preferred embodiment. The sliding mechanism 100 in the illustrated embodiment, is used to interconnect a first case 50 and a second case 60 of a mobile phone 500. A keypad 62 is formed on a surface of the second case 60. A display 52 and a secondary keypad 54 are formed on a surface of the first case 50. The first case 50 is slidable relative to the second case 60 by means of the sliding mechanism 100. In an open position, the first case 50 slides away from the second case 60 allowing operation of the keypad 62. In a closed position, the first case 50 covers the keypad 62, thus protecting the keypad 62. While the sliding mechanism 100 is shown in use with the mobile phone 500, it is to be understood that the sliding mechanism 100 or obvious variations thereof may prove useful in other work environments (e.g., personal digital assistants) as well.

The sliding mechanism 100 includes a first sliding member 10, a second sliding member 20, and at least one cushion 30. In the illustrated embodiment, there are two cushions 30. The two cushions 30 are securely mounted to the first sliding member 10. The second sliding member 20 is slidable relative to the first sliding member 10 and the cushions 30.

The first sliding member 10 has a first body 11. The first body 11 is substantially a flat board in shape. Each corner of the first body 11 defines a first screw hole 112 therein. A guiding rail 12 is directly formed at each of two opposite sides of the first body 11. Each guiding rail 12 is substantially strip-shaped. Two projections 121 are respectively directly formed at two opposite ends of each guiding rail 12. The two projections 121 extend away from each other. The projection 121, the guiding rail 12, and the first body 11 cooperate to define a receiving groove 123.

The second sliding member 20 has a second body 21. The second body 21 is substantially a flat board in shape. Each corner of the second body 21 defines a second screw hole 212 therein. A pair of guiding arms 22 is symmetrically and directly formed at two opposite sides of the second body 21. Each guiding arm 22 is substantially U-shaped and defines a guiding slot 224 therein. The two guiding slots 224 face towards each other.

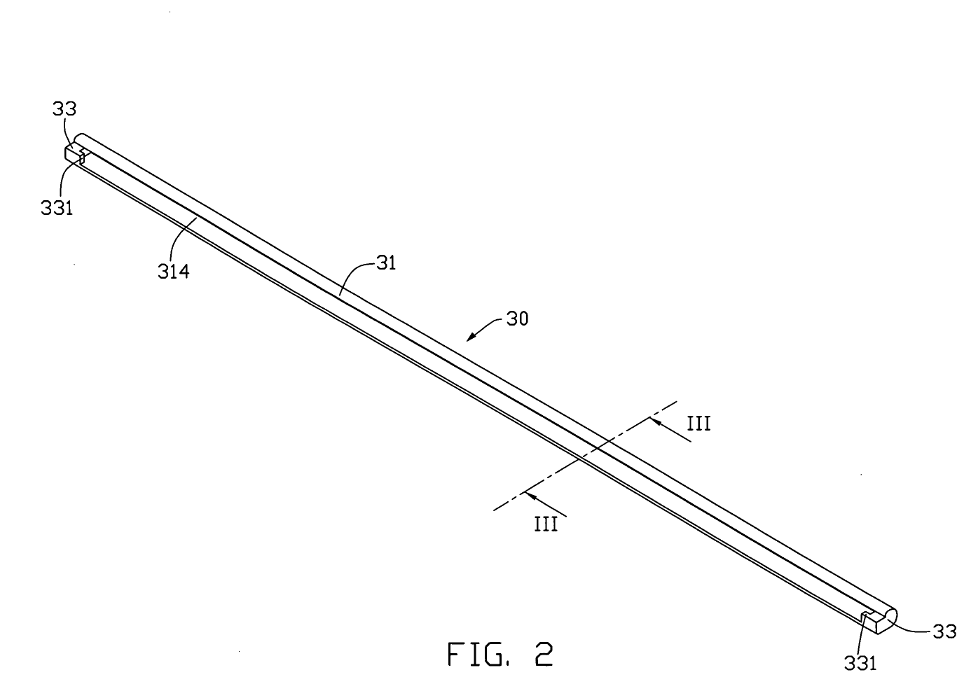

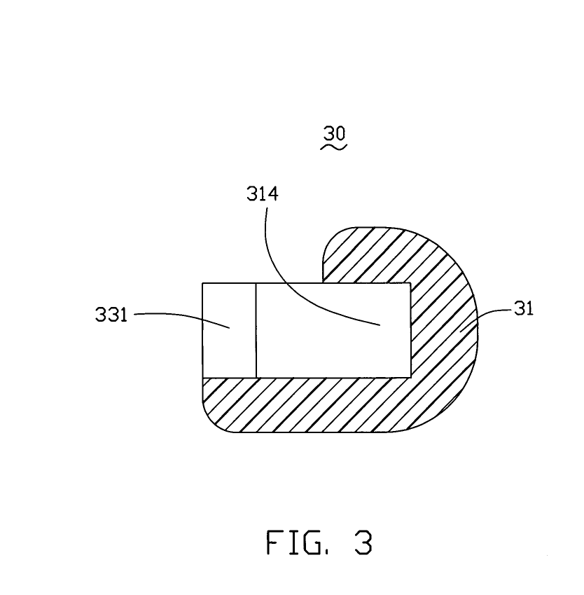

Also further referring to FIGS. 2-3 as well as FIG. 1, the cushion 30 is advantageously made from plastic and has a main body 31. The main body 31 is a substantially deformed strip in shape and is configured for receipt in one corresponding guiding slot 224 of the second sliding member 20. The main body 31 defines a receiving slot 314 therein. The guiding rail 12 of the first sliding member 10 is configured for receipt in one corresponding receiving slot 314. A block 33 is directly formed at each of two opposite ends of the main body 31. A protrusion 331 extends from an outer distal end of each block 33. The two protrusions 331 extend toward each other. The protrusion 331 is configured for receipt in one corresponding receiving groove 123 thereby allowing the cushion 30 to be mounted to the first sliding member 10.

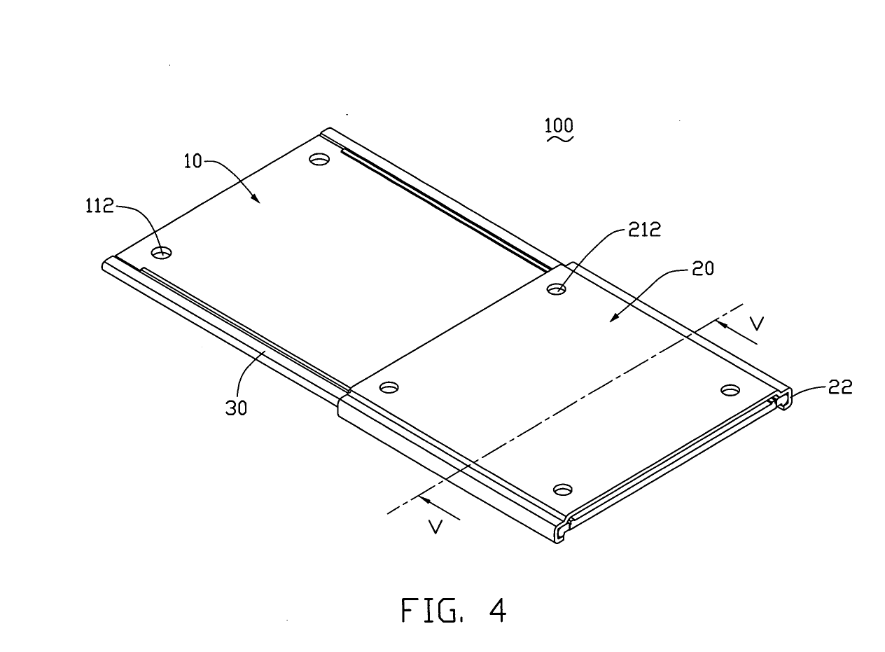

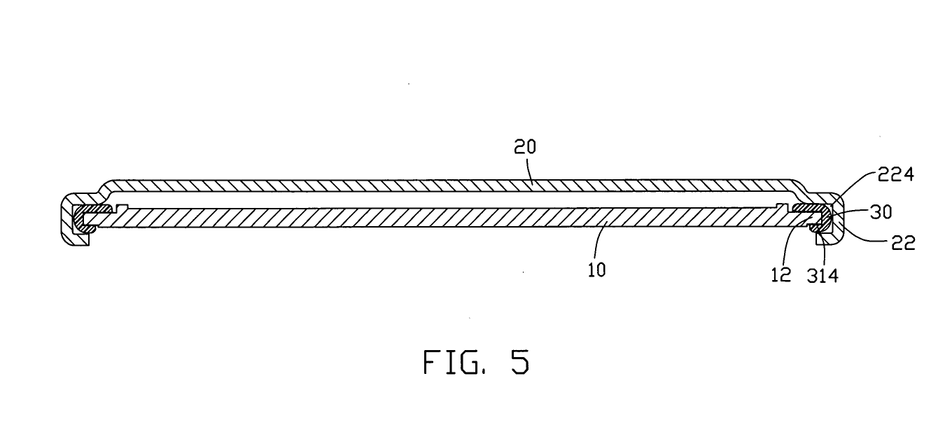

In assembly, each guiding rail 12 of the first sliding member 10 is interferentially received in the receiving slot 314 of one corresponding cushion 30. Each protrusion 331 of the cushion 30 is engaged in the receiving groove 123 of the first sliding member 10. The assembled first sliding member 10 and the cushions 30 are mounted to the second sliding member 20 with each cushion 30 sliding into one corresponding guiding slot 224 of the second sliding member 20. Thus, the sliding mechanism 100 is completely assembled, as represented in FIGS. 4-5.

In use, the first sliding member 10 is mounted to the first case 50 of the mobile phone 500 by a bolt being screwed in each first screw hole 112. The second sliding member 20 is mounted to the second case 60 of the mobile phone 500 by a bolt being screwed in each second screw hole 212. The first case 50 is mounted to the second case 60 by the above-described assembling process. Thus, the first case 50 is slidable relative to the second case 60, thereby opening/closing the mobile phone 500, by means of the sliding mechanism 100.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sliding mechanism comprising:
a first sliding member having a first body, at least one guiding rail being formed on the first body;
a second sliding member having a second body, wherein at least one guiding arm is formed on the second body, and wherein the guiding arm defines a guiding slot; and
at least one cushion, the cushion having a main body, the main body defining a receiving slot therein, the guiding rail being reception in the receiving slot, and the cushion being sandwiched between the guiding rail and the guiding arm.

2. The sliding mechanism as claimed in claim 1, wherein an interlocking structure is formed between the cushion and the guiding rail for locking the cushion with the guiding rail.

3. The sliding mechanism as claimed in claim 2, wherein two projections are respectively formed at two opposite ends of the guiding rail, the projection, the guiding rail, and the first body cooperate to define a receiving groove, two blocks are respectively formed at two opposite ends of the main body of the cushion, a protrusion extends from an outer distal end of each block, and the protrusion being receipt in one corresponding receiving groove thereby allowing the cushion to be locked to the first sliding member.

4. The sliding mechanism as claimed in claim 1, wherein the cushion is made from plastic.

5. The sliding mechanism as claimed in claim 1, wherein the guiding rail is substantially strip-shaped.

6. The sliding mechanism as claimed in claim 5, wherein the guiding arm has a substantially U-shaped cross section.

7. The sliding mechanism as claimed in claim 1, wherein the second body of the second sliding member has two guiding arms and two guiding slots, the two guiding slots face towards each other.

8. A portable electronic device, comprising:
a first case;
a second case; and
a sliding mechanism slidably interconnecting the first case and the second case, the sliding mechanism comprising:
a first sliding member mounted to the first case, the first sliding member having a first body, at least one guiding rail being formed on the first body;
a second sliding member mounted to the second case, the second sliding member having a second body, at least one guiding arm being formed at the second body, the guiding arm defining a guiding slot therein, and the guiding rail of the first sliding member being configured for slidable reception in the guiding slot; and
at least one cushion being sandwiched between the guiding rail and the guiding arm.

9. The portable electronic device as claimed in claim 8, wherein the cushion has a main body, the main body defines receiving slot therein, and the guiding rail is configured for receipt in the receiving slot.

10. The portable electronic device as claimed in claim 9, wherein two projections are respectively formed at two opposite ends of the guiding rail, the projection, the guiding rail, and the first body cooperate to define a receiving groove, two blocks are respectively formed at two opposite ends of the main body, a protrusion extends from an outer distal end of each block, and the protrusion is configured for receipt in one corresponding receiving groove thereby allowing the cushion to be mounted to the first sliding member.

11. The portable electronic device as claimed in claim 8, wherein the cushion is made from plastic.

12. The portable electronic device as claimed in claim 8, wherein the guiding rail is substantially strip-shaped.

13. The portable electronic device as claimed in claim 12, wherein the guiding arm is substantially U-shaped.

14. The portable electronic device as claimed in claim 8, wherein the second body of the second sliding member has two guiding arms and two guiding slots, the two guiding slots face towards each other.

15. A portable electronic device, comprising:
a first case;
a second case;
a sliding mechanism slidably interconnecting the first case and the second case in a lengthwise direction, the sliding mechanism comprising:
a first sliding member fixed to the first case, the first sliding member having a first body, a pair of guiding rails extending from opposite lengthwise sides of the first body;
a second sliding member fixed to the second case, the second sliding member having a second body, a pair of guiding arms being formed at opposite lengthwise sides of the second body, the guiding arms defining a pair of guiding slots facing toward each other; and
a pair of cushions extending in the lengthwise direction, each of the cushions being deformed and sandwiched between one of the guiding rails and a corresponding guiding arm in a corresponding guiding slot in such a manner that the cushion is fixedly attached to the first sliding member while the second sliding member is slidably attached to the cushion.

16. The portable electronic device as claimed in claim 15, wherein each of the cushions defines a receiving slot extending in the lengthwise direction, each of the guiding rails being interferentially received in the receiving slot of the corresponding cushion.

17. The portable electronic device as claimed in claim 16, wherein each of the guiding arm has a U-shaped cross section sandwiching the corresponding cushion combined with the corresponding guiding rail therein.

18. The portable electronic device as claimed in claim 16, wherein each of the guiding rails defines a pair of grooves at opposite ends thereof, and each of the cushions forms a pair of blocks at opposite ends of the receiving slot sandwiching the corresponding guiding rail therebetween in the lengthwise direction, a pair of protrusions extend toward each other from the blocks, and each protrusion is inserted into a corresponding groove to prevent the cushion disengaging from the corresponding guiding rail.

19. The portable electronic device as claimed in claim 15, wherein the guiding arms are bent from the opposite sides of the second body of the second sliding member.
